(19) United States
(12) Patent Application Publication
(10) Pub. No.: US 2023/0070536 A1
(43) Pub. Date: Mar. 9, 2023

(54) STREAMING MATRIX TRANSPOSE HARDWARE

(71) Applicant: Intel corporation, Santa Clara, CA (US)

(72) Inventor: Kamlesh Pillai, Bangalore (IN)

(21) Appl. No.: 18/051,379

(22) Filed: Oct. 31, 2022

(51) Int. Cl. G06F 7/78

(52) U.S. Cl. CPC G06F 7/78

(57) ABSTRACT

Systems, apparatuses and methods may provide for technology that includes transposition hardware and a data controller coupled to the transposition hardware, the data controller to detect an input instruction, transfer, based on the input instruction, stored matrix data from a memory to the transposition hardware, and configure the transposition hardware to stream output transposed matrix data associated with the stored matrix data.

### TECHNICAL FIELD

Embodiments generally relate to matrix operations in neural network applications. More particularly, embodiments relate to streaming matrix transpose hardware in artificial intelligence (AI) accelerators.

### BACKGROUND OF THE DISCLOSURE

Artificial Intelligence (AI) accelerators may be useful in supporting a relatively high computation demand that is common in Deep Neural Network (DNN)-based applications. Generally, these accelerators employ hundreds of arithmetic units (e.g., fused multiply-add/FMA units), to achieve computational requirements. The computations are typically represented in a matrix form, with matrix transpose operations (e.g., “transpose”) being performed at various stages of the DNN. For example, neural networks frequently process weights and inputs of different sizes, where the dimensions do not satisfy the requirements for matrix multiplication. Accordingly, matrix transpose provides a way to “rotate” one of the matrices so that the operations comply with multiplication requirements and the accelerator hardware can continue. Matrix transpose may be conducted at various training stages (e.g., forward propagation, backward propagation, loss function computation, gradient descent for finding local minima, etc.). Conventional matrix transpose solutions, however, may increase the power budget, performance budget and/or execution latency of the accelerator.

### BRIEF DESCRIPTION OF THE DRAWINGS

The various advantages of the embodiments will become apparent to one skilled in the art by reading the following specification and appended claims, and by referencing the following drawings, in which:

FIGS. 1A-1D are an illustration of an example of a transposition engine data flow table according to an embodiment;

FIG. 2 is a schematic diagram of an example of an accelerator according to an embodiment;

FIG. 3A is a schematic diagram of an example of a transposition engine according to an embodiment;

FIG. 3B is a schematic diagram of an example of a switch according to an embodiment;

FIG. 4 is an illustration of an example of a transition data flow table between a parallel mode and a serial mode according to an embodiment;

FIG. 5 is an illustration of an example of an input multiplexer state table according to an embodiment;

FIG. 6 is an illustration of an example of an output multiplexer state table according to an embodiment;

FIGS. 7A and 7B are illustrations of examples of input and output tables, respectively, for a scenario in which a row dimension of stored matrix data is greater than a row dimension of memory according to an embodiment;

FIGS. 8A and 8B are illustrations of examples of input and output tables, respectively, for a scenario in which stored matrix data includes non-square matrices according to an embodiment;

FIGS. 9A and 9B are illustrations of examples of input and output tables, respectively, for a scenario in which a width of memory is greater than a width of an interface between a data controller and the memory according to an embodiment;

FIG. 10 is a block diagram of an example of an accelerator in which transposition hardware is replicated to increase throughput according to an embodiment;

FIG. 11A is an illustration of an example of an output table for an accelerator in which transposition hardware is replicated according to an embodiment;

FIG. 11B is an illustration of an example of a state table for a partial merge and write back block according to an embodiment;

FIG. 12 is an illustration of an example of synthesis area and power data according to an embodiment;

FIG. 13 is a flowchart of an example of a method of operating a compute engine according to an embodiment;

FIG. 14 is a flowchart of an example of a method of operating a data controller according to an embodiment;

FIG. 15 is a block diagram of an example of a performance-enhanced computing system according to an embodiment;

FIG. 16 is an illustration of an example of a semiconductor package apparatus according to an embodiment;

FIG. 17 is a block diagram of an example of a processor according to an embodiment; and

FIG. 18 is a block diagram of an example of a multi-processor based computing system according to an embodiment.

### DETAILED DESCRIPTION

As already noted, matrix transpose operations may be performed at various stages of a deep neural network (DNN). The deep learning technology described herein reduces the time required to perform the transpose of a matrix and enables compute operations to be performed in parallel with matrix transpose operations. More particularly, embodiments provide for enhanced streaming matrix transposition hardware and an instruction to drive that hardware. Additionally, the matrix transpose streaming capability is achieved without experiencing a negative impact on performance, area or power (e.g., relative to current matrix multiplication based DNN accelerators).

In one example, enhanced matrix transpose/transposition hardware is driven by an instruction that supports any memory size and provides one transposed row per cycle. The enhanced hardware employs only a few sets of registers (e.g., flip-flops) along with few multiplexers and control bits (e.g., transpose engines) that hold the intermediate data. A data control circuit (e.g., data controller) dynamically decides how incoming data is to be written to the registers. The data control circuit also decides how written data will be read back to obtain a transposed row at a throughput of one transposed row/cycle. To achieve a streaming behavior, the data control circuit switches between writing serially and parallelly across the set of registers after a fixed number of cycles.

In the parallel mode, the elements of a matrix are read from the memory and written to the same register set. In the serial mode, on the other hand, the elements of a matrix are read from the memory and written to a different register set. The transpose read mode always follows the write mode. Thus, after an initial latency of few cycles, the proposed solution can stream one transposed row of matrix elements per cycle at a rate equal to the memory bandwidth. For a larger matrix, the data controller internally divides the matrix data into smaller matrices and computes the address accordingly to make ensure that data is rearranged in an appropriate order. The proposed solution is also capable of handling the transpose of a non-square matrix. Indeed, implementation and synthesis results show that the proposed solution can be scaled to different memory sizes and bandwidths, with a minimum area impact.

For example, a transpose of a matrix may be performed where each element is a 32-bit floating-point number (e.g., fp32) with a memory bandwidth of 16 Bytes/cycle. Thus, each read from the memory will provide four elements of fp32. In the illustrated example, four transpose engines (e.g., each with a register of 128 bits) is arranged as 4 X 128 bits, where each row is capable of handling 128 bits. During a parallel write operation transpose engines are written one by one, while in case of serial write mode one element of fp32 is written per transpose engine. At the end of the fourth cycle, the write mode is toggled (e.g., either from serial to parallel or parallel to serial) and continues to the next set of write operations to the transpose engines. Similarly, at the end of the fourth cycle, read hardware activates a read mode that follows the current write mode (e.g., if the current write mode is serial, the read mode will be serial and vice versa). Thus, it is feasible to read transposed matrix data every cycle.

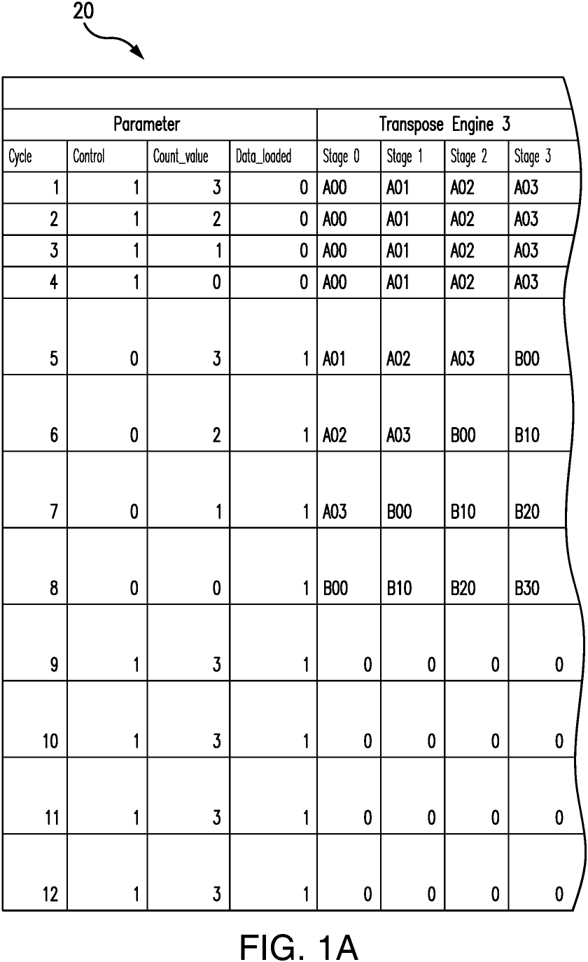

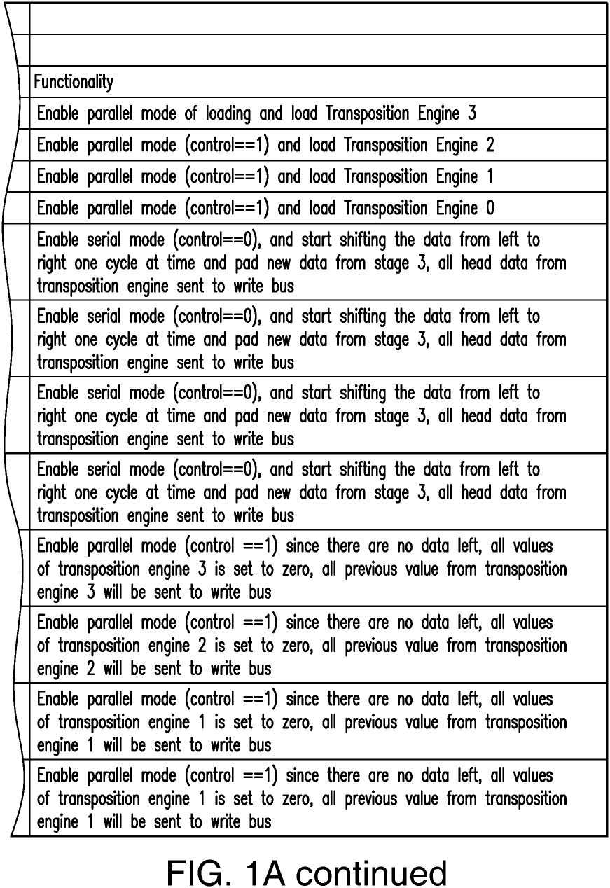

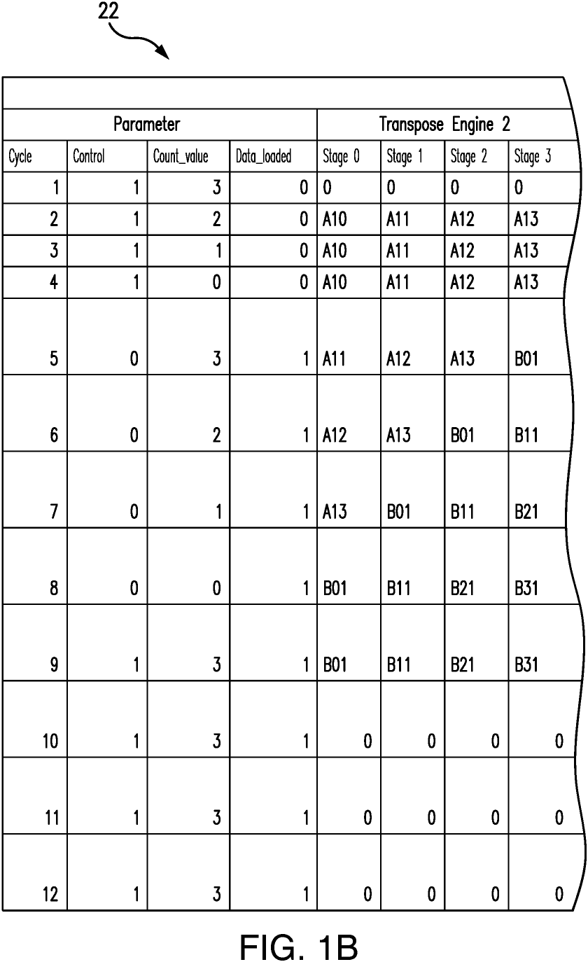

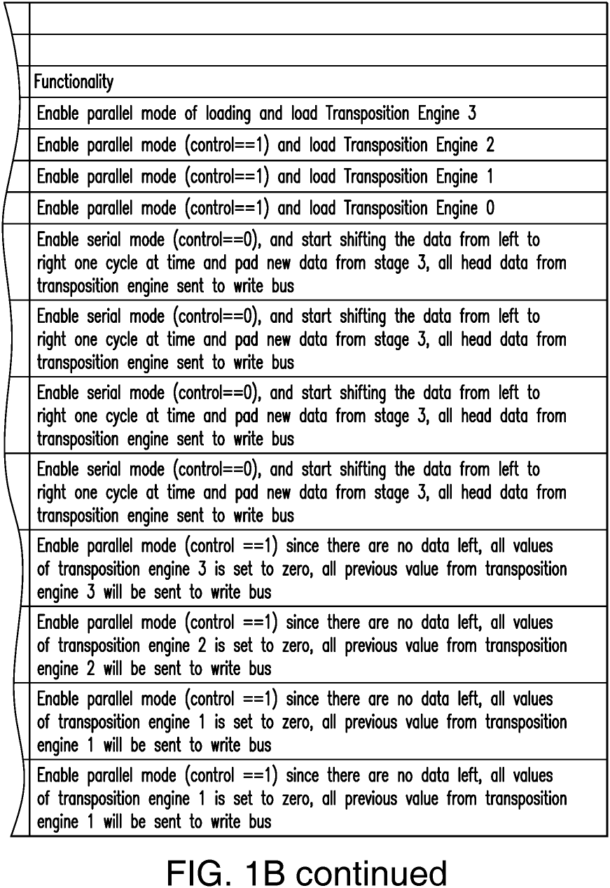

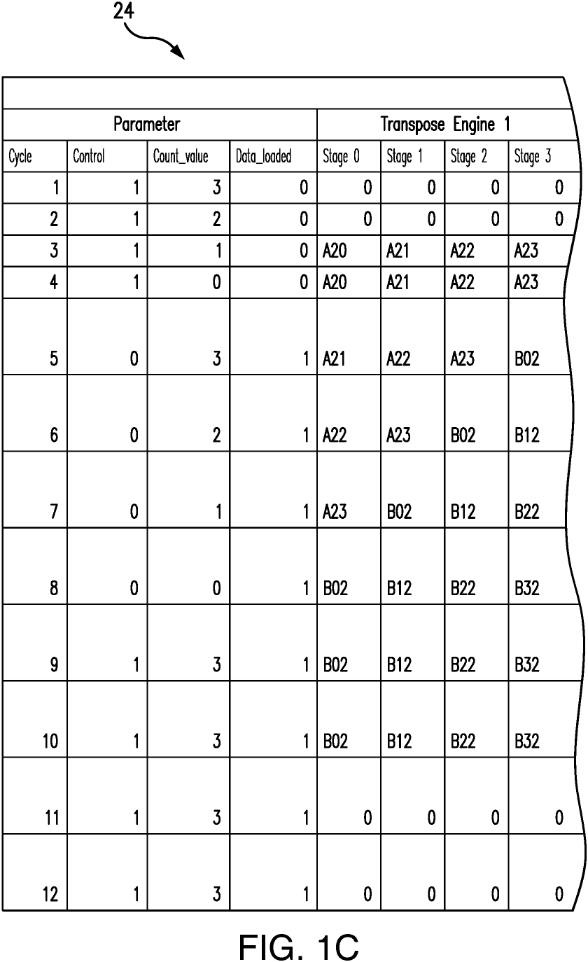

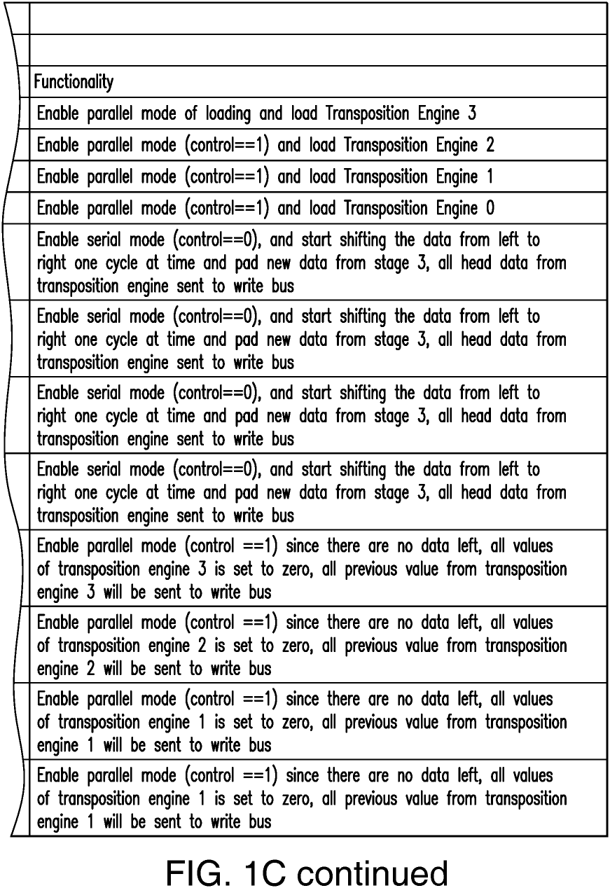

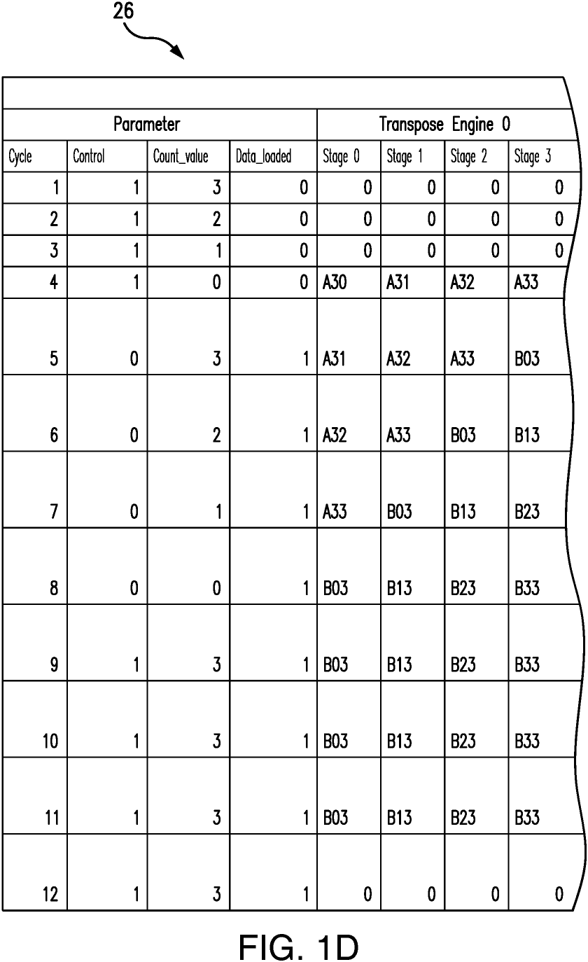

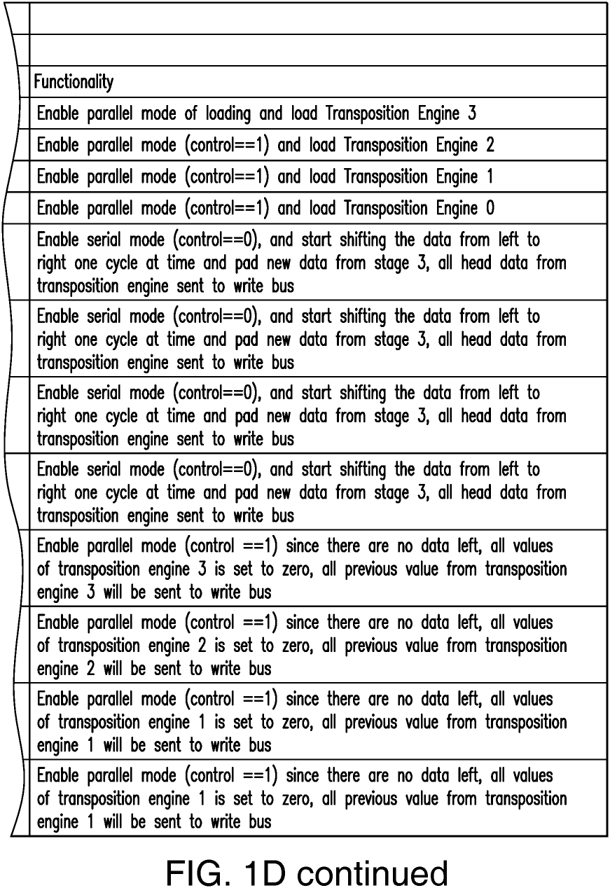

FIGS. 1A-1D show portions 20, 22, 24, 26 of a transposition engine data flow table in which matrix “A” (e.g., containing elements A00 through A33) and matrix “B” (e.g., containing elements B00 through B33) are shown as two 4x4 matrices (e.g., elements are indexed as A/B_{(row},_{column)}). Matrix A and B can be considered different matrices, or segments of a larger matrix broken down internally as two independent 4x4 matrices.

The data flow operations in the illustrated example are as follows.

Cycle 1: read A00, A01, A02, A03 from memory and load all of the elements into transpose engine 3, as best shown in portion 20 of the data flow table.

Cycle 2: read A10, A11, A12, A13 from memory and load all of the elements into transpose engine 2, as best shown in portion 22 of the data flow table.

Cycle 3: read A20, A21, A22, A23 from memory and load all of the elements into transpose engine 1, as best shown in portion 24 of the data flow table.

Cycle 4: read A30, A31, A32, A33 from memory and load all of the elements into transpose engine 0, as best shown in portion 26 of the data flow table.

Cycle 5: Data loaded bit is set high indicating that writing output can commence as all transpose engines are full. The control bit is also set to zero. Thus, B00, B01, B02, and B03 are read and loaded in a serial manner, one element per transpose engine. The first row of transposed matrix A is read in serial (e.g., one element from the head of each transpose engine and remaining data are shifted towards the head of the engine).

Cycle 6: read B10, B11, B12, B13 and start loading the elements in a serial manner, one element per transpose engine. The previous data is also shifted to the next stage within the transpose engine. The second row of transposed matrix A is read in serial mode (e.g., one element from the head of each transpose engine and remaining data are shifted towards the head of the engine.)

Cycle 7: read B20, B21, B22, B23 and start loading the elements in serial manner, one element per transpose engine. The previous data is also shifted to the next stage within the transpose engine. The third row of transposed matrix A is read in serial mode (e.g., one element from head of each transpose engine and remaining data are shifted towards the head of the engine.)

Cycle 8: read B30, B31, B32, B33 and start loading the elements in serial manner, one element per transpose engine. The previous data is also shifted to the next stage within the transpose engine. The fourth row of transposed matrix A is read in serial mode (e.g., one element from head of each transpose engine and remaining data are shifted towards the head of the engine.)

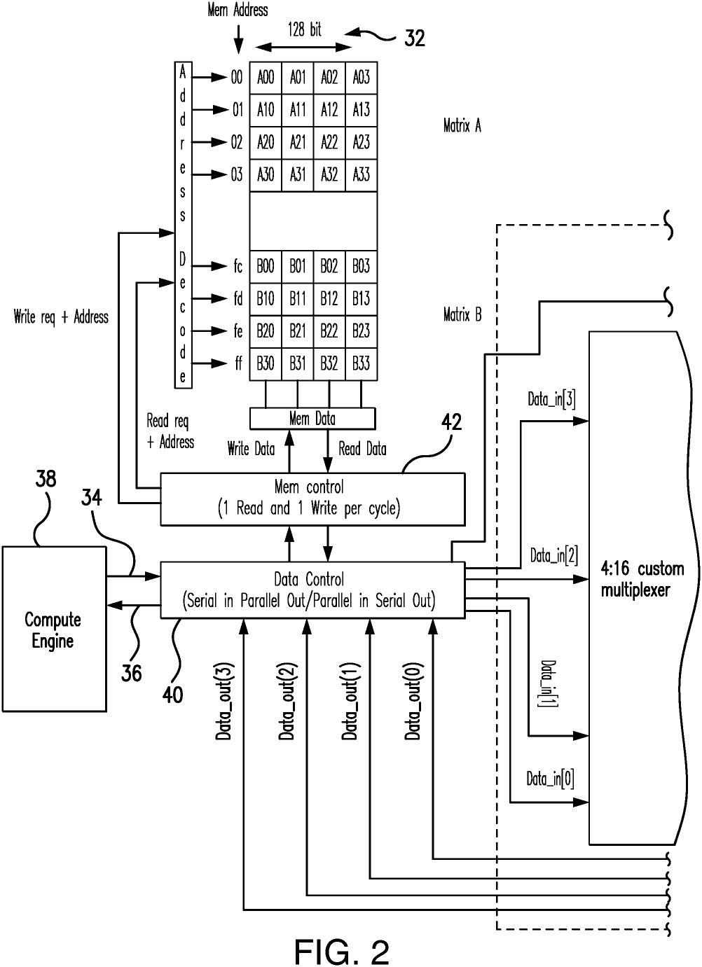

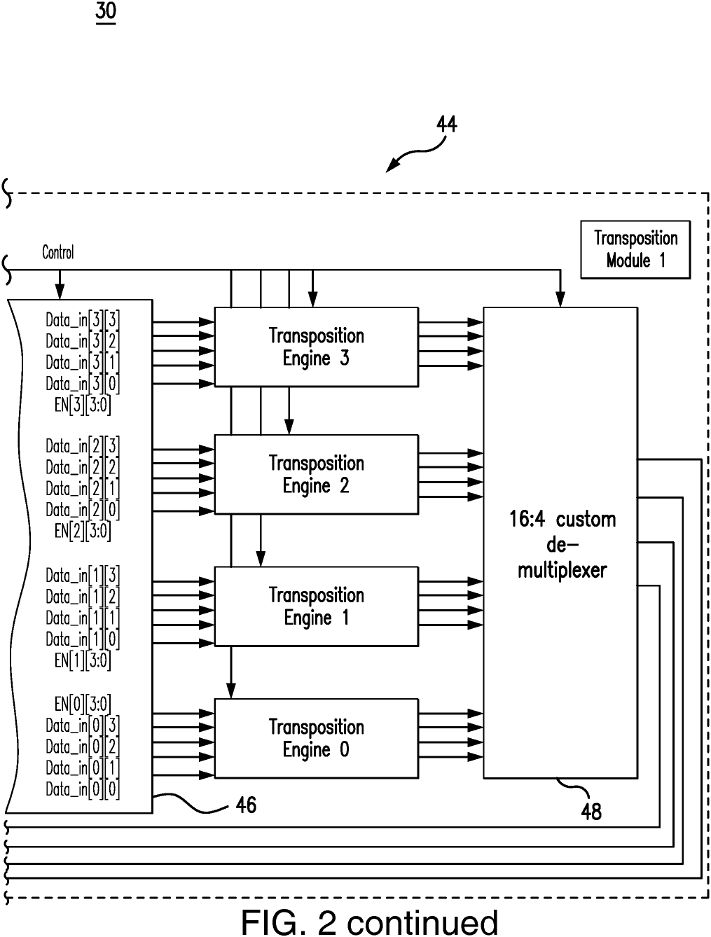

FIG. 2 shows an AI accelerator 30 in which a 128-bit wide memory 32 holds two matrices of 4x4 elements (e.g., matrix A and matrix B), where each element is a fp32. Accordingly, each read from the memory 32 will return four fp32 elements per cycle. More particularly, matrix A is stored from location 00h - 03h with each location holding four fp32 elements. For discussion purposes, a matrix of 4x4 is used to demonstrate the hardware functionality. The same hardware functionality, however, may be used for larger matrix sizes and different cases, as will be discussed in greater detail.

An enhanced input instruction 34 is defined as TMNMXD, “transpose matrix ‘N’ byte memory and X data, where the N is number of bytes per wordline of the memory 32 (e.g., memory width) and X is the number matrices for which the transpose operation is to be performed. For example, if the memory 32 has a 16-byte wide wordline in which the source matrix is stored, then for a single matrix the instruction 34 is TM16M1D.

The argument format of the new instruction 34 is TMNMXD tsrcdest, tsrcl, tsrc2, tsrc3. There are two modes in which the instruction 34 can function: Mode One -write the transpose output 36 to the memory 32 (e.g., tsrcdest is specified as an address); Mode Two - when the write to the memory 32 is being bypassed and all bits in tsrcdest are set to high. The parameter tsrcl specifies the base address of the matrix in the memory 32, wherein the parameters tsrc2 and tsrc3 provide original matrix row and column dimensions, respectively.

Thus, a compute engine 38 of the accelerator 30 may determine the wordline size of the memory 32 and the number of matrices to be transposed, incorporate the wordline size and the number of matrices into the input instruction 34, and issue the input instruction 34 to a data controller 40. The compute engine 38 may also incorporate a base address (e.g., tsrc1) of a matrix in the memory 32, a row dimension (e.g., tsrc2) of the matrix, and a column dimension (e.g., tsrc3) of the matrix into the input instruction 34. In one example, the row dimension is different from the column dimension (e.g., the matrix is non-square). The compute engine 38 may also incorporate a destination address (e.g., tsrcdest) into the input instruction 34 if the transposed matrix data is being written to the memory 32. In one example, the compute engine 38 performs one or more matrix multiplication operations on the transpose output 36 (e.g., transposed matrix data) associated with the input instruction 34 while the transpose output 36 is being streamed out.

In an embodiment, the data controller 40 reads and decodes the input instruction 34, and instructs a memory controller 42 to issue a read request for matrix A. Each read row is passed to the data controller 40, which updates the counter and control bit based on the counter value. The control bit specifies how the input data is to be loaded into a plurality of transpose engines 44. The input data is loaded in parallel to a single transposition engine (e.g., if control bit == 1) or one element per transposition engine (e.g., if control bit == 0).

The counter in the data controller 40 starts from a value of three and decrements to a value of zero. Once the counter reaches zero, the control bit is complemented and the counter is reset to the value of three. Operation of the output is same as how the data is currently being loaded. Thus, if the control bit == 1 - the data is being loaded in parallel - then the output will be read in parallel mode (e.g., the output will be read from a single transposition engine). Similarly, if the control bit == 0 - the data is being loaded in serial manner across the plurality of transposition engines 44 - then the output will be read in serial manner, one element from each transposition engine.

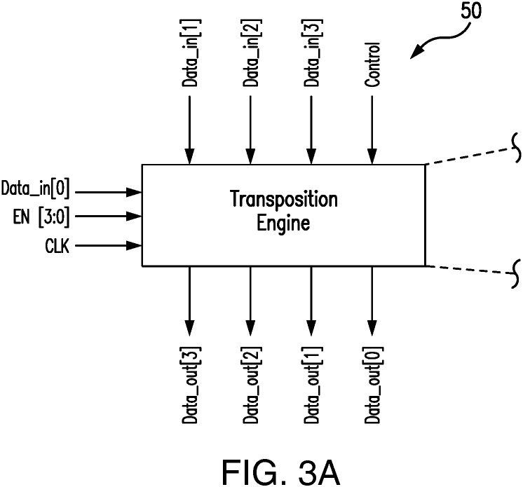

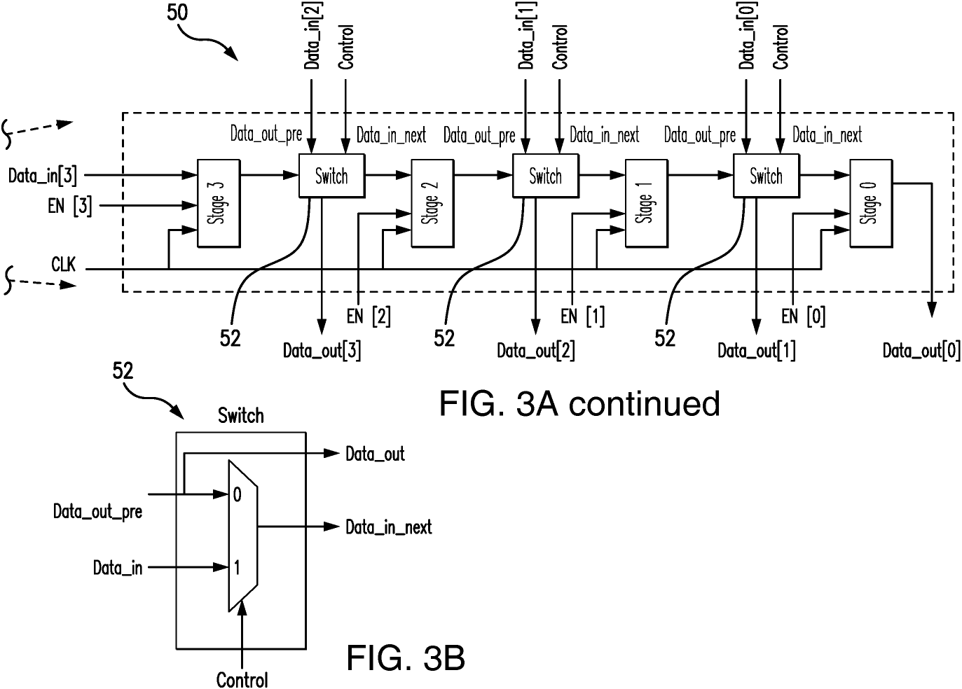

FIGS. 3A and 3B show a transposition engine 50 that may be readily substituted for each of the plurality of transposition engines 44 (FIG. 2) and a switch 52 that may be incorporated into the transposition engine 50. To generalize the operation per transposition engine 50, control bit == 1, will trigger a parallel load and parallel read, whereas control bit == 0 will trigger a serial load and serial read. In the case of serial load/read, one element from each transposition engine 50 is used to fill the write/read data bandwidth. In an embodiment, the read starts only when all transpose engines 50 have been written to. In one example, the transposition engine 50 includes four stages of registers connected using the switch 52, which is a simple multiplexer to enable serial-in /parallel-in operation between the subsequent stages of registers. In this case, each stage includes 32 bits of registers and each stage is enabled by an enable (EN) signal.

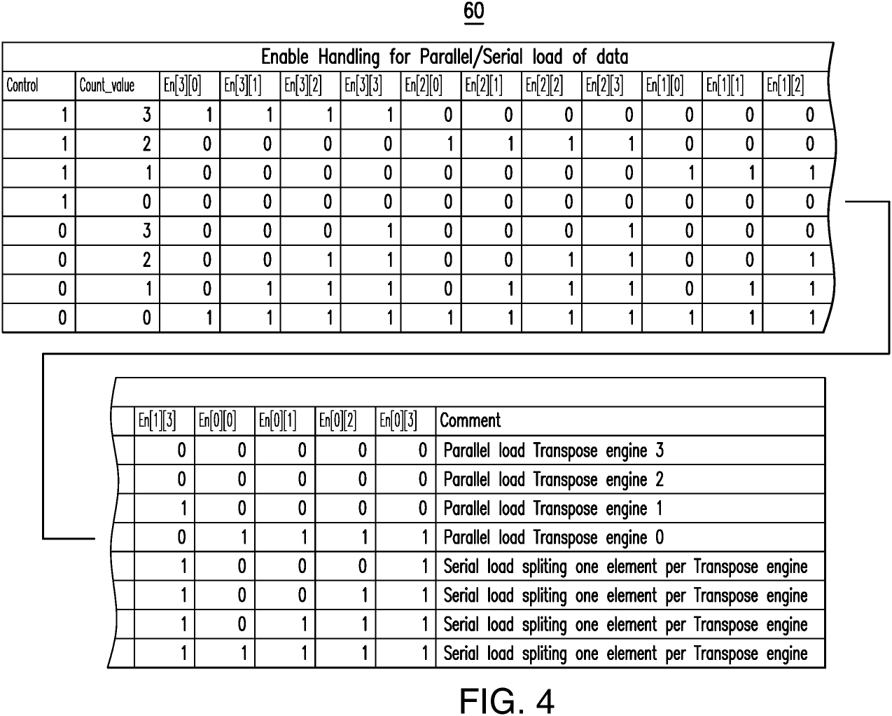

FIG. 4 shows a transition data flow table 60 between the parallel mode and the serial mode. The operations shown are as follows.

1) Control == 1 && count value == 3 all enable bits of transpose engine 3 are enabled (e.g., read data can be loaded in all four stages, one element per stage).

2) Control == 1 && count value == 2 all enable bits of transpose engine 2 are enabled (e.g., read data can be loaded in all four stages, one element per stage).

3) Control == 1 && count value == 1 all enable bits of transpose engine 1 are enabled (e.g., read data can be loaded in all four stages, one element per stage).

4) Control == 1 && count value == 0 all enable bits of transpose engine 0 are enabled (e.g., read data can be loaded in all four stages, one element per stage).

5) Control == 0 && count value == 3, one enable bit of each transpose engine is enabled (e.g., read data can be loaded in one stage, one element per transpose engine).

6) Control == 0 && count value == 2, one enable bit of each transpose engine is enabled (e.g., read data can be loaded in one stage, one element per transpose engine). Previous data will be pushed to next stage within the same transpose engine.

7) Control == 0 && count value == 1, one enable bit of each transpose engine is enabled (e.g., read data can be loaded in one stage, one element per transpose engine). Previous data will be pushed to next stage within the same transpose engine.

8) Control == 0 && count value == 0, one enable bit of each transpose engine is enabled (e.g., read data can be loaded in one stage, one element per transpose engine). Previous data will be pushed to next stage within the same transpose engine.

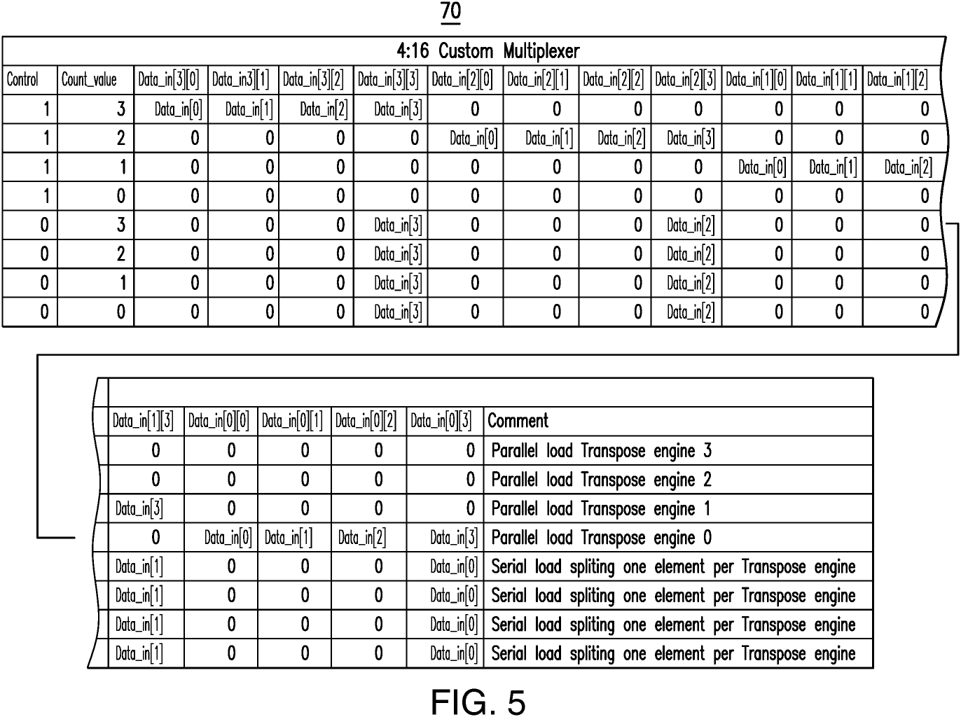

Turning now to FIGS. 2 and 5, a state table 70 is shown for an input multiplexer 46. In general, the input multiplexer 46 receives stored matrix data and outputs intermediate matrix data. The plurality of transpose engines 44 are coupled to the input multiplexer 46, wherein the plurality of transpose engines 44 hold the intermediate matrix data. More particularly, with each read from the memory 32, {Data_in[3],Data_in[2],Data_in[1],Data_in[0]} may be received. For parallel load mode (e.g., control == 1) the data is loaded as shown in the state table 70. The same operation repeats for all combinations of control and count_values.

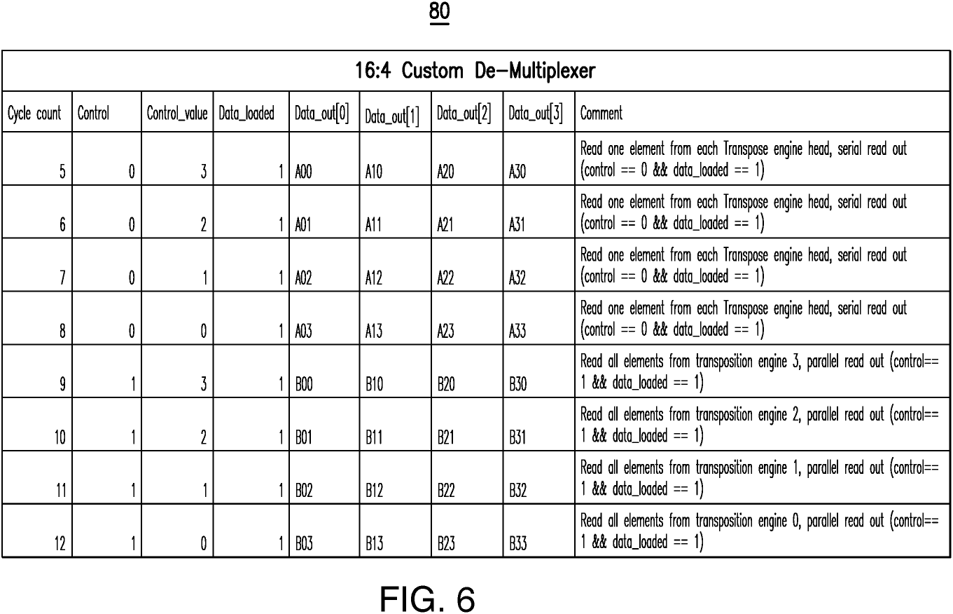

With continuing reference to FIGS. 2 and 6, a state table 80 is shown for an output multiplexer 48. In general, the output multiplexer 48 is coupled to the plurality of transpose engines 44 and outputs the transposed matrix data. More particularly, the output write operation writes the transposed matrix row back to the memory 32 and/or the compute engine 38. The operations occur as follows.

For the first four cycles, the data_loaded bit is low because the transposition engine is not filled. From cycle 5 onward, the data_loaded bit is set high.

Cycle 5: Since control == 0, read one element from each transpose engine (e.g., {A00, A10, A20, A30}).

Cycle 6: Since control == 0, read one element from each transpose engine (e.g., {A01, A11, A21, A31}).

Cycle 7: Since control == 0, read one element from each transpose engine (e.g., {A02, A12, A22, A32}).

Cycle 8: Since control == 0, read one element from each transpose engine (e.g., {A03, A13, A23, A33}).

Cycle 9: Since control == 1, read all elements from single transpose engine 3 (e.g., {B00, B10, B20, B30}).

Cycle 10: Since control == 1, read all elements from single transpose engine 2 (e.g., {B01, B11, B21, B31}).

Cycle 11: Since control == 1, read all elements from single transpose engine 1 (e.g., {B02, B12, B22, B32}).

Cycle 12: Since control == 1, read all elements from single transpose engine 0 (e.g., {B03, B13, B23, B33}).

### Additional Scenario #1 (One Matrix Row Spans Multiple Memory Rows)

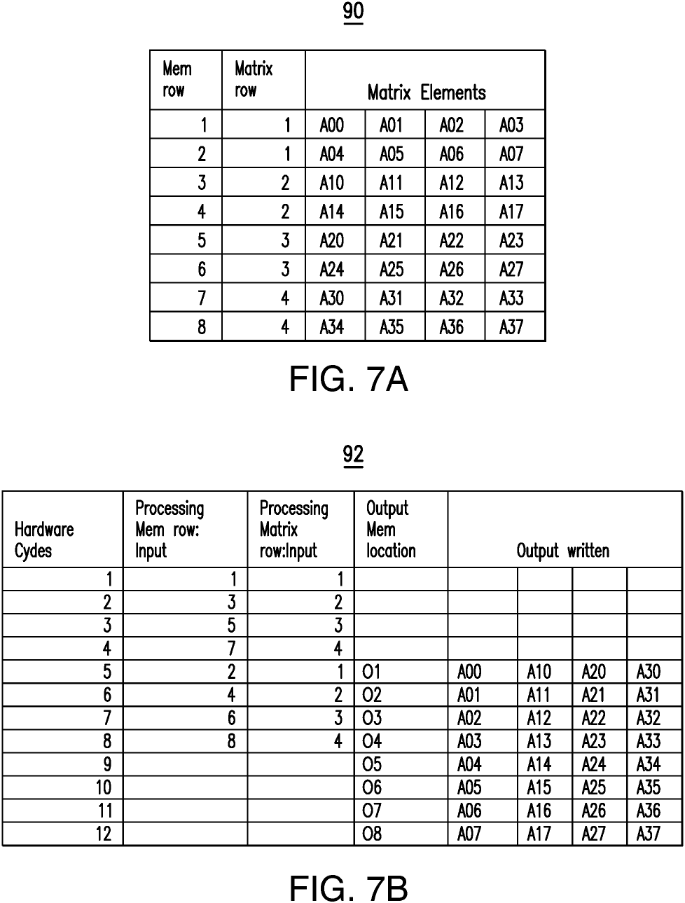

Turning now to FIGS. 7A and 7B, an input table 90 shows that two memory rows may be needed to occupy one matrix row (e.g., A00-A07). Thus, the row dimension of the stored matrix data is greater than the row dimension of the memory (e.g., wordline dimension, memory width). In such a case, the data controller may interleave one or more read operations from the memory. For example, an output table 92 demonstrates that the memory controller may start reading all odd memory rows first and then read even memory rows. Accordingly, the interleaving operation mimics the case in which odd memory locations form one 4X4 matrix and even locations form other 4X4 matrix. The operation then follows the same flows as explained in previous example of matrix A and B. The output is written as shown in the output table 92.

### Additional Scenario #2 (Number of Rows Are Greater Than the Number of Columns)

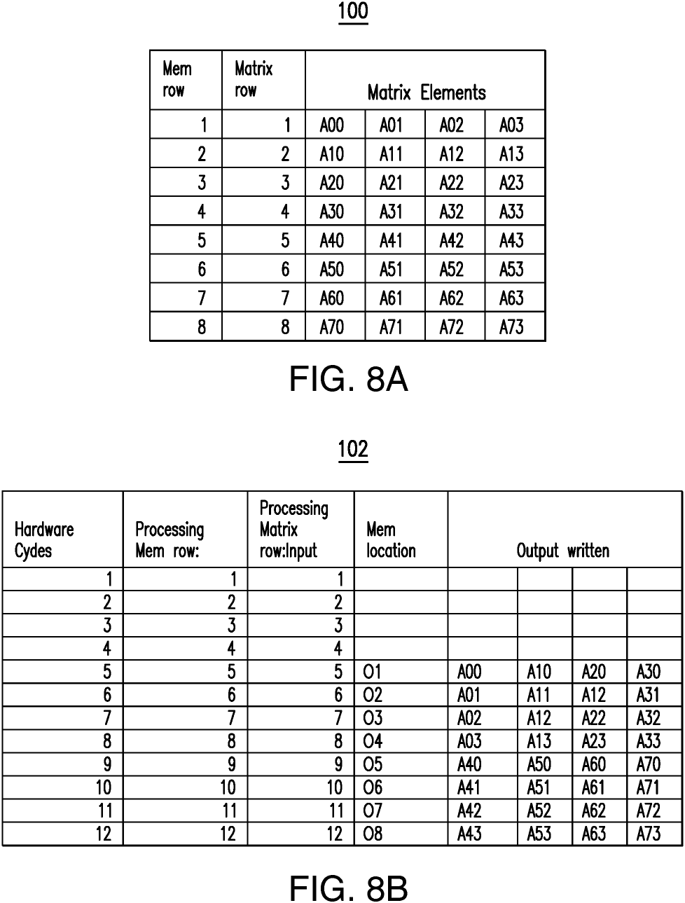

Turning now to FIGS. 8A and 8B, an input table 100 demonstrates that one row of a matrix may fit within a memory row but the number of rows may be greater than the number of columns (e.g., the transpose will have more columns than rows). Thus, the stored matrix data may include non-square matrices. In such a case, the data controller may interleave one or more write operations from the transpose hardware. For example, the input table 100 demonstrates that the input matrix may include eight rows and four columns in matrix A. The hardware operates on the matrix row by row. An output table 102 shows that while writing out the result, the data controller generates output addresses in such a way that transpose matrix is written first at the odd locations and then onto the even location. Accordingly, the transpose matrix is written in a correct order where each matrix row will fit into more than one memory row.

### Additional Scenario #3 (Memory Width is Greater Than the Hardware Width)

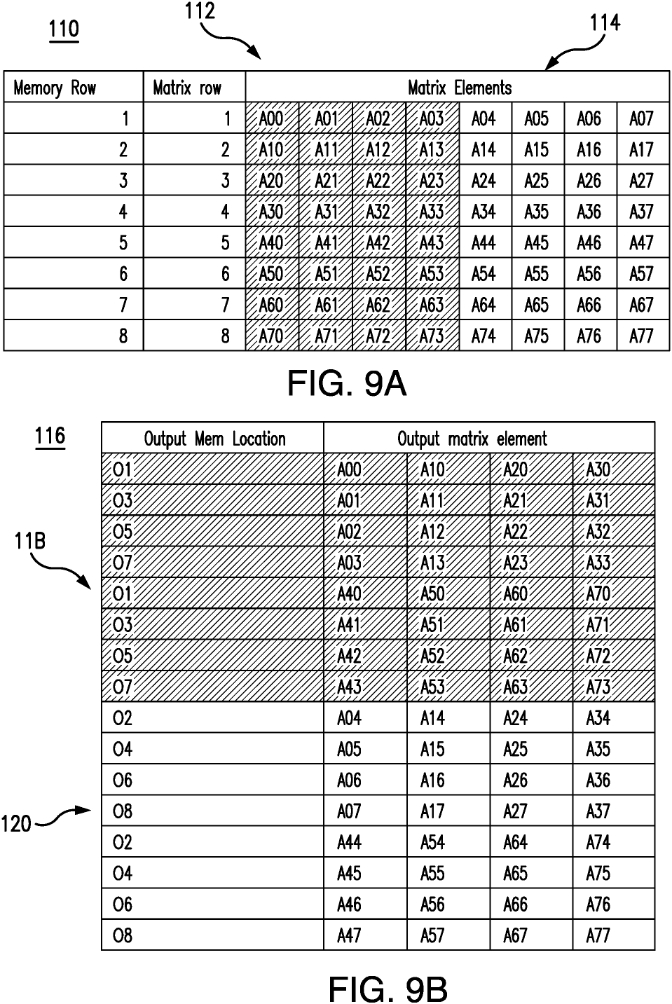

Turning now to FIGS. 9A and 9B, an input table 110 demonstrates that, for example, the memory width might be eight fp32 elements and the hardware width might be four fp32 elements. The matrix of 8X8 will be fitted in the memory as shown in the input table 110. In such a case, the data controller may duplicate read operations from locations in the memory. Thus, since the hardware width is half of the memory width, each memory location will be read twice. First, a downward walk is performed in the memory using the hardware width, which produces a resultant matrix of the hardware width. Then, a read of the next set of elements of the same data is performed again from the start of the matrix. A first portion 112 of the input table 110 represents the first read sequence and a second portion 114 of the input table 110 represents the second read sequence. For writing the data out, a first portion 118 of an output table 116 corresponds to a first write out cycle for one transposed matrix row and a second portion 120 of the output table 116 corresponds to a second write out cycle for another transposed matrix row.

### Additional Scenario #4 (Scalability)

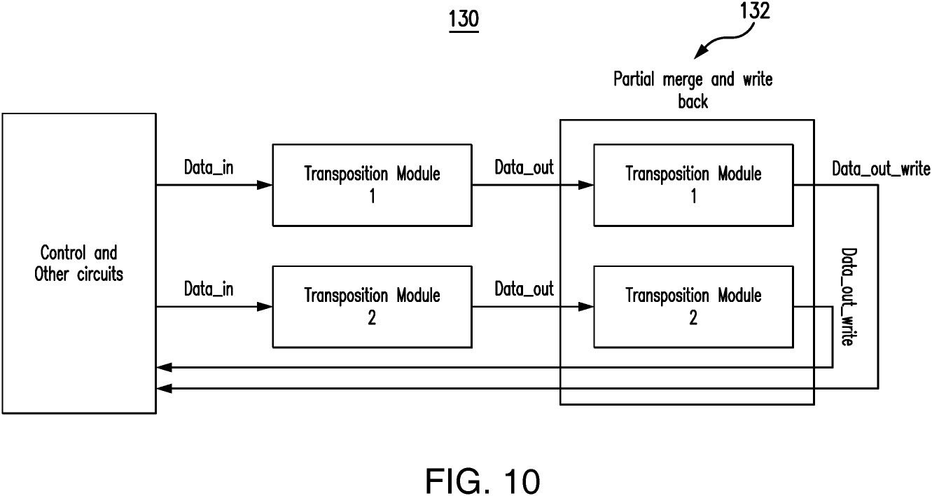

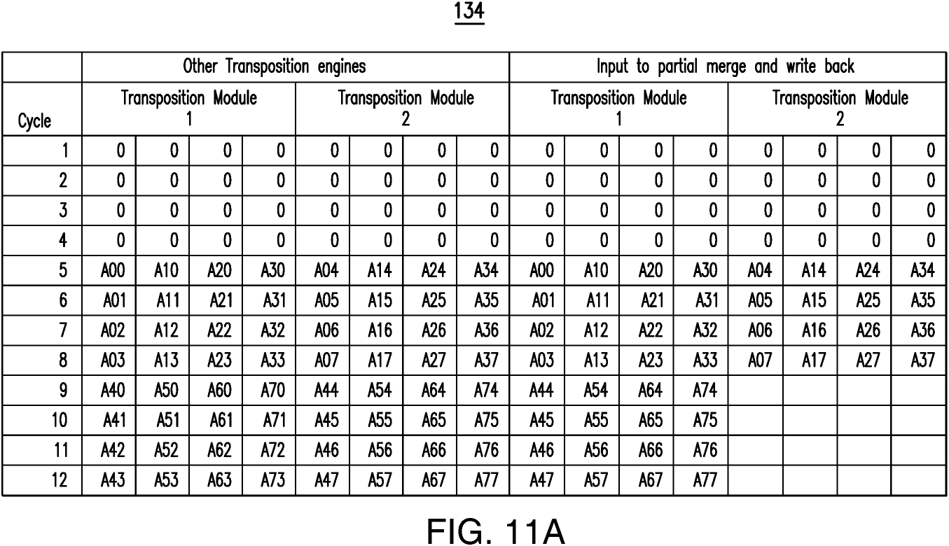

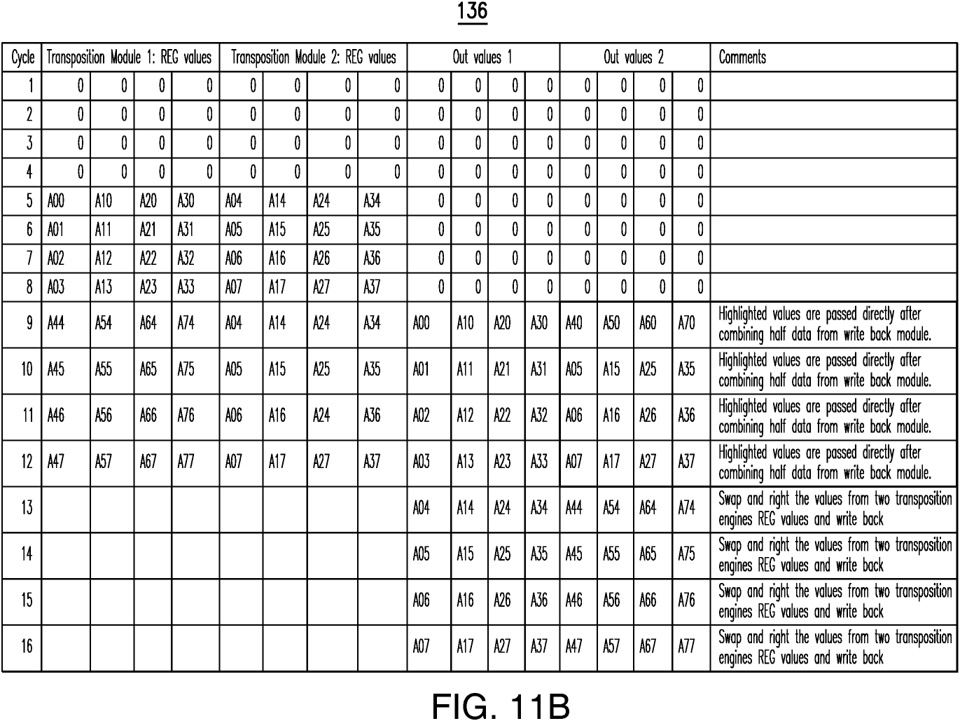

Turning now to FIG. 10-11B, an accelerator 130 is shown for a solution that increases the throughput from ½ row per cycle to one row per cycle based on scenario #3. This increase can be achieved by replicating the hardware as a partial merge and write back block 132 that collects partial writes and then issuing write requests. For the same example mentioned in scenario #3, two transposition modules handle the operation.

More particularly, the accelerator 130 reads one row of memory and feeds the row to both transposition modules in the partial merge and write back block 132 either in a serial manner (control == 0, e.g., one element per transposition engines across all transposition modules) or in a parallel manner (control == 1, e.g., all elements split equally across one transposition engines in each transposition modules). An output table 134 demonstrates that output from transposition module 1 and 2 are written directly to the modules in partial merge and write back block 132. Once the transposition modules within the partial merge and write back block 132 are full, only module 1 is loaded, while other module data is held without affecting the previous value.

A state table 136 shows how data flows from the transposition modules inside the partial merge and write back block 132. More particularly, from cycle 5 onwards transposition modules 1 and 2 start writing out values to the partial merge and write back block 132 as shown the output table 134. Each output is directly stored in the partial merge and write back block 132. Once the transposition modules in the partial merge and write back block 132 is full, from cycle 9 onwards the transposed data is written back to memory.

During the first four cycles of the write sequence, half the output (e.g., four elements) is merged from partial merge and write back block 132 and the other half is read directly from the input to the partial merge and write back block 132. Remaining inputs are stored in the location within partial merge and write back block 132 from where four elements were pushed out on the write bus. This pattern continues for four cycles and then groups of four elements are swapped within the partial merge and write back block 132. Then four further write requests are issued. With each write from cycle 13 onwards, one location from each transposition module is read, which helps in pipelining the further processing in case of larger matrix dimensions.

This same policy mentioned in scenario #4 is valid for any memory width, by scaling/replicating the transposition modules to match the width of the memory. Moreover, changes within transposition modules are unnecessary and there is no need to match the other matrix dimensions.

### Synthesis Area and Power Data

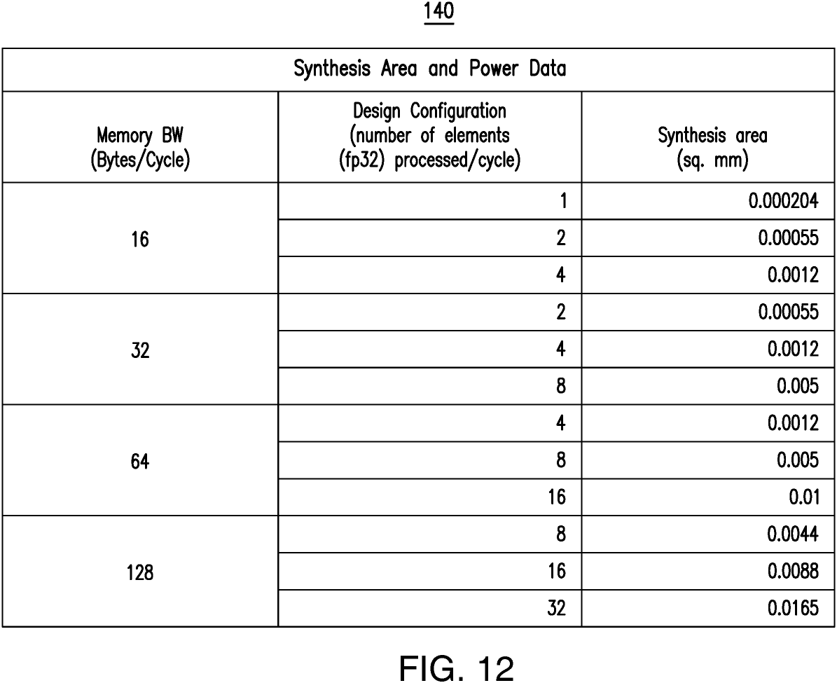

FIG. 12 shows a synthesis area and power data table 140 in which each transposition module block and control takes around ~1100 sq.microns. Additionally, synthesis power is measured to be ~0.9-1.0 mW (milliWatts). In the case of matching the memory width of different sizes, the area of the design can be estimated as shown in the table 140. Design configurations can be taken based on how many cycles are used to fill the resultant data (e.g., how many parallel elements can be transposed per cycle). For cases where the number of matrix rows/matrix columns does not align with memory width, a few extra read cycles may used to align the row/column elements. For aligned cases, the hardware utilization will be 100% whereas, for non-aligned cases utilization may drop slightly. This loss of utilization can be compensated by having one extra read port/overloading write port with the read.

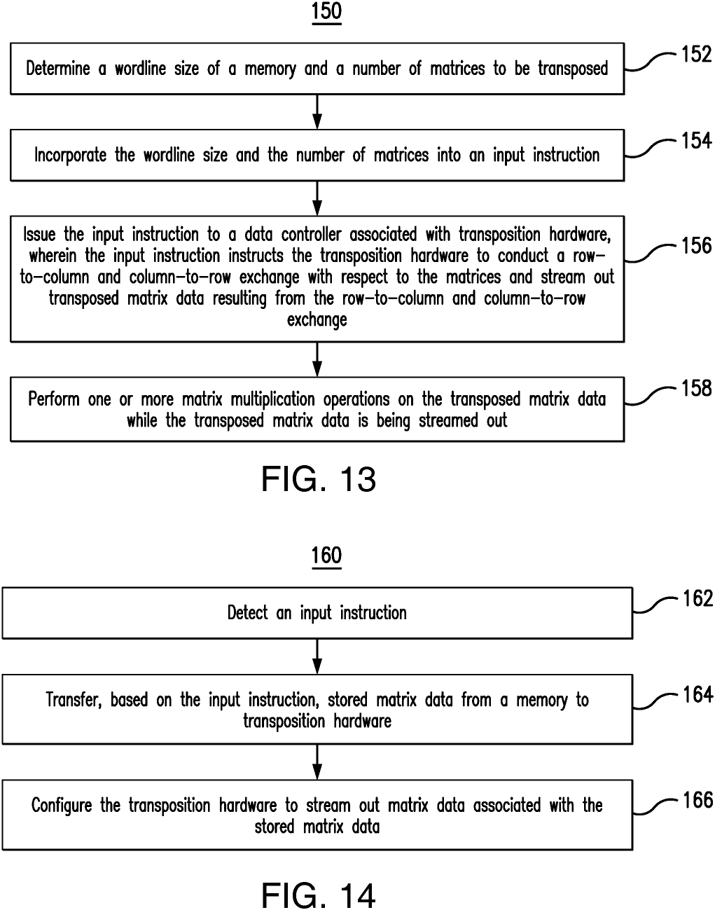

FIG. 13 shows a method 150 of operating a compute engine. The method 150 may generally be implemented in a compute engine such as, for example, the compute engine 38 (FIG. 2), already discussed. More particularly, the method 150 may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Computer program code to carry out operations shown in the method 150 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 152 provides for determining a wordline size (e.g., memory width) of a memory and a number of matrices to be transposed. In an embodiment, block 154 incorporates the wordline size and the number of matrices into an input instruction. Block 154 may also incorporate a base address of a matrix in the memory, a row dimension of the matrix, a column dimension of the matrix and/or a destination address into the input instruction. In one example, the row dimension is different from the column dimension. Block 156 issues the input instruction to a data controller associated with transposition hardware, wherein the input instruction instructs the transposition hardware to conduct a row-to-column and column-to-row exchange with respect to the matrices and stream out transposed matrix data resulting from the row-to-column and column-to-row exchange. Additionally, block 158 may perform one ore more matrix multiplication operations on the transposed matrix data while the transposed matrix data is being streamed out.

The method 150 therefore enhances performance at least to the extent that the input instruction enables streaming behavior and reduces latency with respect to matrix transposition operations. The ability to specify any number of matrices and different wordline sizes also enhances performance by enabling the data controller to take memory bandwidth and wordline dimension into consideration internally (e.g., before commencing the transpose operation). Moreover, performing matrix multiplication on the transposed matrix data while the transposed matrix data is being streamed out further reduces latency.

FIG. 14 shows a method 160 of operating a data controller. The method 160 may generally be implemented in a data controller such as, for example, the data controller 40 (FIG. 2), already discussed. More particularly, the method 160 may be implemented in one or more modules as a set of logic instructions stored in a machine- or computer-readable storage medium RAM, ROM, PROM, firmware, flash memory, etc., in hardware, or any combination thereof.

Illustrated processing block 162 provides for detecting an input instruction. In one example, the input instruction specifies and/or includes a wordline size of a memory and a number of matrices to be transposed. Block 164 transfers, based on the input instruction, stored matrix data from the memory to transposition hardware. In one example, block 164 includes interleaving one or more read operations from the memory (e.g., when a row dimension of the stored matrix data is greater than a row dimension of the memory). Block 164 may also duplicate read operations from locations in the memory (e.g., when a width of the memory is greater than a width of an interface between the data controller and the memory). Block 166 configures the transposition hardware to stream out transposed matrix data associated with the stored matrix data. In an embodiment, one row of the transposed matrix data is streamed per cycle at a rate associated with a bandwidth of the memory. Moreover, block 166 may include transitioning the transposition hardware between a parallel mode and a serial mode based on a state of the transposition hardware. In one example, block 166 includes interleaving one or more write operations from the transposition hardware (e.g., when the stored matrix data includes non-square matrices).

The method 160 therefore enhances performance at least to the extent that configuring the transposition hardware to stream out transposed matrix data eliminates latency penalties incurred by conventional solutions. Moreover, the streaming behavior can be achieved with just few sets of registers instead of memory duplication as in conventional solutions. Unlike in-memory compute solutions, the method 160 is easy to realize and can be implemented for mainstream commercial products. The method 160 is also more adaptable to performing transposes of a non-square matrices and larger matrix sizes.

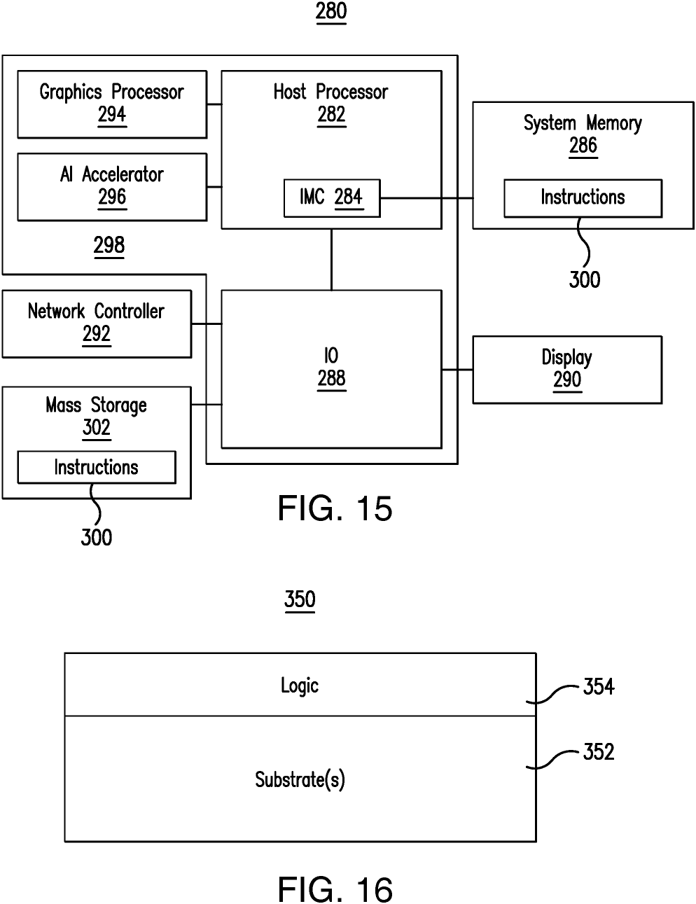

Turning now to FIG. 15, a performance-enhanced computing system 280 is shown. The system 280 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof.

In the illustrated example, the system 280 includes a host processor 282 (e.g., central processing unit/CPU) having an integrated memory controller (IMC) 284 that is coupled to a system memory 286 (e.g., dual inline memory module/DIMM). In an embodiment, an IO (input/output) module 288 is coupled to the host processor 282. The illustrated IO module 288 communicates with, for example, a display 290 (e.g., touch screen, liquid crystal display/LCD, light emitting diode/LED display), mass storage 302 (e.g., hard disk drive/HDD, optical disc, solid state drive/SSD) and a network controller 292 (e.g., wired and/or wireless). The host processor 282 may be combined with the IO module 288, a graphics processor 294, and an AI accelerator 296 into a system on chip (SoC) 298.

In an embodiment, the AI accelerator 296 includes the accelerator 30 (FIG. 2), already discussed. Thus, the AI accelerator 296 may include a compute engine that performs one or more aspects of the method 150 (FIG. 13) and a data controller that performs one or more aspects of the method 160 (FIG. 14).

The computing system 280 is therefore considered performance-enhanced at least to the extent that an input instruction enables streaming behavior and reduces latency with respect to matrix transposition operations. The ability to specify any number of matrices and different wordline sizes also enhances performance by enabling the data controller to take memory bandwidth and wordline dimension into consideration internally (e.g., before commencing the transpose operation). Moreover, performing matrix multiplication on the transposed matrix data while the transposed matrix data is being streamed out further reduces latency.

The computing system 280 is also considered performance-enhanced at least to the extent that configuring a transposition hardware to stream out transposed matrix data eliminates latency penalties incurred by conventional solutions. Moreover, the streaming behavior can be achieved with just few sets of registers instead of memory duplication as in conventional solutions. Unlike in-memory compute solutions, the computing system 280 is easy to realize and can be implemented for mainstream commercial products. The computing system 280 is also more adaptable to performing transposes of a non-square matrices and larger matrix sizes.

FIG. 16 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. In an embodiment, the logic 354 implements one or more aspects of the method 150 (FIG. 13) and/or the method 160 (FIG. 14), already discussed. The logic 354 may also include the accelerator 30 (FIG. 2).

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

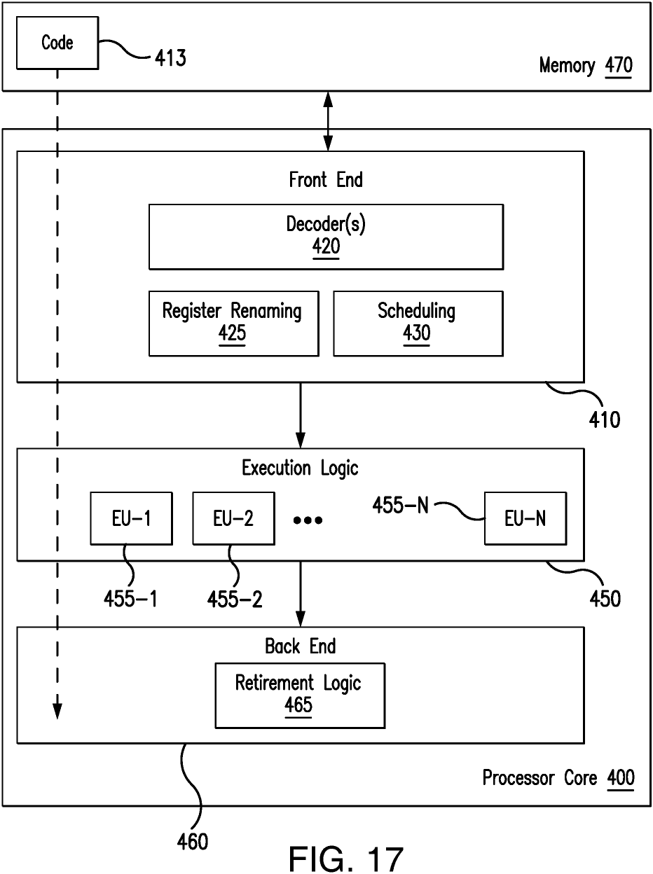

FIG. 17 illustrates a processor core 400 according to one embodiment. The processor core 400 may be the core for any type of processor, such as a micro-processor, an embedded processor, a digital signal processor (DSP), a network processor, or other device to execute code. Although only one processor core 400 is illustrated in FIG. 17, a processing element may alternatively include more than one of the processor core 400 illustrated in FIG. 17. The processor core 400 may be a single-threaded core or, for at least one embodiment, the processor core 400 may be multithreaded in that it may include more than one hardware thread context (or “logical processor”) per core.

FIG. 17 also illustrates a memory 470 coupled to the processor core 400. The memory 470 may be any of a wide variety of memories (including various layers of memory hierarchy) as are known or otherwise available to those of skill in the art. The memory 470 may include one or more code 413 instruction(s) to be executed by the processor core 400, wherein the code 413 may implement the method 150 (FIG. 13) and/or the method 160 (FIG. 14), already discussed. The processor core 400 follows a program sequence of instructions indicated by the code 413. Each instruction may enter a front end portion 410 and be processed by one or more decoders 420. The decoder 420 may generate as its output a micro operation such as a fixed width micro operation in a predefined format, or may generate other instructions, microinstructions, or control signals which reflect the original code instruction. The illustrated front end portion 410 also includes register renaming logic 425 and scheduling logic 430, which generally allocate resources and queue the operation corresponding to the convert instruction for execution.

The processor core 400 is shown including execution logic 450 having a set of execution units 455-1 through 455-N. Some embodiments may include a number of execution units dedicated to specific functions or sets of functions. Other embodiments may include only one execution unit or one execution unit that can perform a particular function. The illustrated execution logic 450 performs the operations specified by code instructions.

After completion of execution of the operations specified by the code instructions, back end logic 460 retires the instructions of the code 413. In one embodiment, the processor core 400 allows out of order execution but requires in order retirement of instructions. Retirement logic 465 may take a variety of forms as known to those of skill in the art (e.g., re-order buffers or the like). In this manner, the processor core 400 is transformed during execution of the code 413, at least in terms of the output generated by the decoder, the hardware registers and tables utilized by the register renaming logic 425, and any registers (not shown) modified by the execution logic 450.

Although not illustrated in FIG. 17, a processing element may include other elements on chip with the processor core 400. For example, a processing element may include memory control logic along with the processor core 400. The processing element may include I/O control logic and/or may include I/O control logic integrated with memory control logic. The processing element may also include one or more caches.

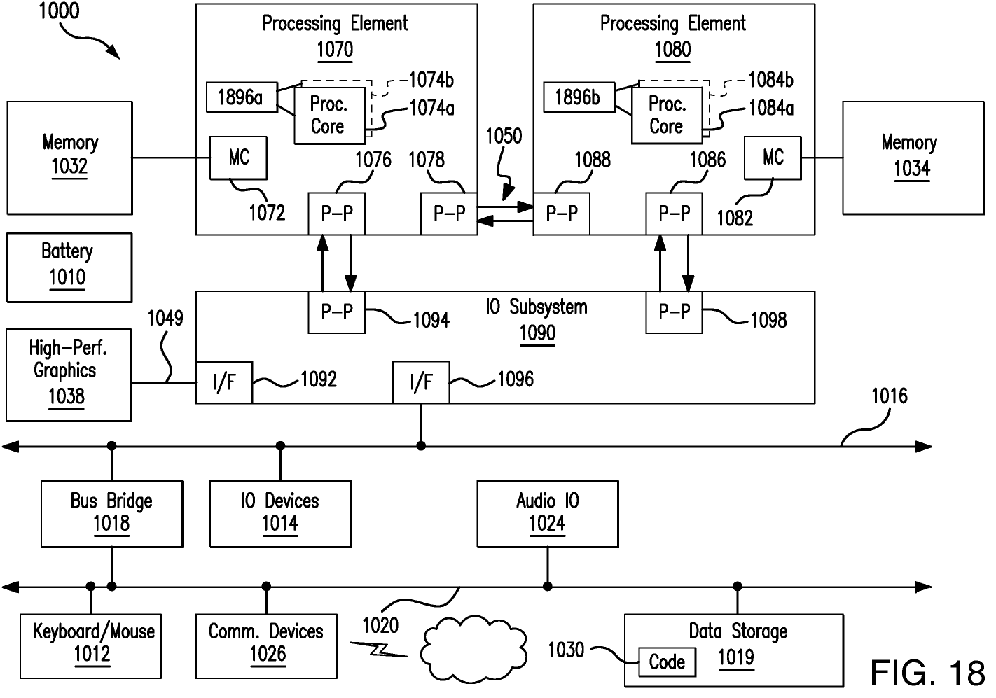

Referring now to FIG. 18, shown is a block diagram of a computing system 1000 embodiment in accordance with an embodiment. Shown in FIG. 18 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 18 may be implemented as a multi-drop bus rather than point-to-point interconnect.

As shown in FIG. 18, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 17.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 18, MC’s 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 18, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 18, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 150 (FIG. 13) and/or the method 160 (FIG. 14), already discussed. Further, an audio I/O 1024 may be coupled to second bus 1020 and a battery 1010 may supply power to the computing system 1000.

Note that other embodiments are contemplated. For example, instead of the point-to-point architecture of FIG. 18, a system may implement a multi-drop bus or another such communication topology. Also, the elements of FIG. 18 may alternatively be partitioned using more or fewer integrated chips than shown in FIG. 18.

### Additional Notes and Examples

Example 1 includes a performance-enhanced computing system comprising a compute engine to issue an input instruction, a memory, a memory controller coupled to the memory, transposition hardware, and a data controller coupled to the compute engine, the memory controller, and the transposition hardware, the data controller to detect the input instruction, transfer, based on the input instruction, stored matrix data from the memory to the transposition hardware, and configure the transposition to stream out transposed matrix data associated with the stored matrix data.

Example 2 includes the computing system of Example 1, wherein one row of the transposed matrix data is to be streamed per cycle at a rate associated with a bandwidth of the memory.

Example 3 includes the computing system of Example 1, wherein the data controller is to transition the transposition hardware between a parallel mode and a serial mode based on a state of the transposition hardware.

Example 4 includes the computing system of Example 1, wherein the transposition hardware includes an input multiplexer to receive the stored matrix data and output intermediate matrix data, a plurality of transpose engines coupled to the input multiplexer, the plurality of transpose engines to hold the intermediate matrix data, and an output multiplexer coupled to the plurality of transpose engines, the output multiplexer to generate the transposed matrix data.

Example 5 includes the computing system of Example 1, wherein the stored matrix data is to include non-square matrices, and wherein the data controller is to interleave one or more write operations from the transposition hardware.

Example 6 includes the computing system of Example 1, wherein a row dimension of the stored matrix data is to be greater than a row dimension of the memory, and wherein the data controller is to interleave one or more read operations from the memory.

Example 7 includes the computing system of Example 1, wherein a width of the memory is greater than a width of an interface between the data controller and the memory, and wherein the data controller is to duplicate read operations from locations in the memory.

Example 8 includes the computing system of any one of Examples 1 to 7, wherein the input instruction is to include a wordline size of the memory and a number of matrices to be transposed, and wherein the compute engine is to perform one or more matrix multiplication operations on the transposed matrix data while the transposed matrix data is being streamed out.

Example 9 includes a semiconductor apparatus comprising one or more substrates, and logic coupled to the one or more substrates, wherein the logic is implemented at least partly in one or more of configurable or fixed-functionality hardware, the logic including transposition hardware, and a data controller coupled to the transposition hardware, the data controller to detect an input instruction, transfer, based on the input instruction, stored matrix data from a memory to the transposition hardware, and configure the transposition hardware to stream out transposed matrix data associated with the stored matrix data.

Example 10 includes the semiconductor apparatus of Example 9, wherein one row of the transposed matrix data is to be streamed per cycle at a rate associated with a bandwidth of the memory.

Example 11 includes the semiconductor apparatus of Example 9, wherein the data controller is to transition the transposition hardware between a parallel mode and a serial mode based on a state of the transposition hardware.

Example 12 includes the semiconductor apparatus of Example 9, wherein the transposition hardware includes an input multiplexer to receive the stored matrix data and output intermediate matrix data, a plurality of transpose engines coupled to the input multiplexer, the plurality of transpose engines to hold the intermediate matrix data, and an output multiplexer coupled to the plurality of transpose engines, the output multiplexer to generate the transposed matrix data.

Example 13 includes the semiconductor apparatus of Example 9, wherein the stored matrix data is to include non-square matrices, and wherein the data controller is to interleave one or more write operations from the transposition hardware.

Example 14 includes the semiconductor apparatus of Example 9, wherein a row dimension of the stored matrix data is to be greater than a row dimension of the memory, and wherein the data controller is to interleave one or more read operations from the memory.

Example 15 includes the semiconductor apparatus of Example 9, wherein a width of the memory is greater than a width of an interface between the data controller and the memory, and wherein the data controller is to duplicate read operations from locations in the memory.

Example 16 includes the semiconductor apparatus of any one of Examples 9 to 15, wherein the input instruction is to include a wordline size of the memory and a number of matrices to be transposed.

Example 17 includes the semiconductor apparatus of any one of Examples 9 to 16, wherein the logic coupled to the one or more substrates includes transistor channel regions that are positioned within the one or more substrates.

Example 18 includes at least one computer readable storage medium comprising a set of executable program instructions, which when executed by a computing system, cause the computing system to determine a wordline size of a memory and a number of matrices to be transposed, incorporate the wordline size and the number of matrices into an input instruction, and issue the input instruction to a data controller associated with transposition hardware.

Example 19 includes the at least one computer readable storage medium of Example 18, wherein the set of executable program instructions, when executed, further cause the computing system to incorporate a base address of a matrix in the memory, a row dimension of the matrix, and a column dimension of the matrix into the input instruction.

Example 20 includes the at least one computer readable storage medium of Example 19, wherein the row dimension is to be different from the column dimension.

Example 21 includes the at least one computer readable storage medium of any one of Examples 18 to 20, wherein the executable program instructions, when executed, further cause the computing system to incorporate a destination address into the input instruction.

Example 22 includes the at least one computer readable storage medium of any one of Examples 18 to 21, wherein the instructions, when executed, further cause to computing system to perform one or more matrix multiplication operations on transposed matrix data associated with the input instruction while the transposed matrix data is being streamed out.

Example 23 includes a method of operating a performance-enhanced computing system, the method comprising determining a wordline size of a memory and a number of matrices to be transposed, incorporating the wordline size and the number of matrices into an input instruction, and issuing the input instruction to a data controller associated with transposition hardware.

Example 24 includes the method of Example 23, further including incorporating a base address of a matrix in the memory, a row dimension of the matrix, and a column dimension of the matrix into the input instruction, wherein the row dimension is different from the column dimension.

Example 25 includes the method of any one of Examples 23 to 24, further including incorporating a destination address into the input instruction.

Example 26 includes an apparatus comprising means for performing the method of any one of Examples 23 to 25.

Technology described herein therefore provides for a streaming transpose engine in which streaming behavior is achieved by using a novel data control circuit that can switch read and write operations from serial mode to parallel mode and vice versa. The technology also provides for an instruction to drive the proposed hardware. Moreover, technology described herein enables the division of larger matrix into multiple smaller matrices by data control block. This division is achieved by taking memory bandwidth and wordline dimension into consideration internally. Finite state machines (FSMs) inside the data control block are reprogrammed accordingly before commencing the transpose operation. Additionally, the technology provides for efficient arrangement of control bits to streamline the data through the transpose engines without corrupting the data.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a compute engine to issue an input instruction;
a memory;
a memory controller coupled to the memory;
transposition hardware; and
a data controller coupled to the compute engine, the memory controller, and the transposition hardware, the data controller to detect the input instruction, transfer, based on the input instruction, stored matrix data from the memory to the transposition hardware, and configure the transposition hardware to stream out transposed matrix data associated with the stored matrix data.

2. The computing system of claim 1, wherein one row of the transposed matrix data is to be streamed per cycle at a rate associated with a bandwidth of the memory.

3. The computing system of claim 1, wherein the data controller is to transition the transposition hardware between a parallel mode and a serial mode based on a state of the transposition hardware.

4. The computing system of claim 1, wherein the transposition hardware includes:
an input multiplexer to receive the stored matrix data and output intermediate matrix data;
a plurality of transpose engines coupled to the input multiplexer, the plurality of transpose engines to hold the intermediate matrix data; and
an output multiplexer coupled to the plurality of transpose engines, the output multiplexer to generate the transposed matrix data.

5. The computing system of claim 1, wherein the stored matrix data is to include non-square matrices, and wherein the data controller is to interleave one or more write operations from the transposition hardware.

6. The computing system of claim 1, wherein a row dimension of the stored matrix data is to be greater than a row dimension of the memory, and wherein the data controller is to interleave one or more read operations from the memory.

7. The computing system of claim 1, wherein a width of the memory is greater than a width of an interface between the data controller and the memory, and wherein the data controller is to duplicate read operations from locations in the memory.

8. The computing system of claim 1, wherein the input instruction is to include a wordline size of the memory and a number of matrices to be transposed, and wherein the compute engine is to perform one or more matrix multiplication operations on the transposed matrix data while the transposed matrix data is being streamed out.

9. A semiconductor apparatus comprising:
one or more substrates; and
logic coupled to the one or more substrates, wherein the logic is implemented at least partly in one or more of configurable or fixed-functionality hardware, the logic including:
transposition hardware; and
a data controller coupled to the transposition hardware, the data controller to detect an input instruction, transfer, based on the input instruction, stored matrix data from a memory to the transposition hardware, and configure the transposition hardware to stream out transposed matrix data associated with the stored matrix data.

10. The semiconductor apparatus of claim 9, wherein one row of the transposed matrix data is to be streamed per cycle at a rate associated with a bandwidth of the memory.

11. The semiconductor apparatus of claim 9, wherein the data controller is to transition the transposition hardware between a parallel mode and a serial mode based on a state of the transposition hardware.

12. The semiconductor apparatus of claim 9, wherein the transposition hardware includes:
an input multiplexer to receive the stored matrix data and output intermediate matrix data;
a plurality of transpose engines coupled to the input multiplexer, the plurality of transpose engines to hold the intermediate matrix data; and
an output multiplexer coupled to the plurality of transpose engines, the output multiplexer to generate the transposed matrix data.

13. The semiconductor apparatus of claim 9, wherein the stored matrix data is to include non-square matrices, and wherein the data controller is to interleave one or more write operations from the transposition hardware.

14. The semiconductor apparatus of claim 9, wherein a row dimension of the stored matrix data is to be greater than a row dimension of the memory, and wherein the data controller is to interleave one or more read operations from the memory.

15. The semiconductor apparatus of claim 9, wherein a width of the memory is greater than a width of an interface between the data controller and the memory, and wherein the data controller is to duplicate read operations from locations in the memory.

16. The semiconductor apparatus of claim 9, wherein the input instruction is to include a wordline size of the memory and a number of matrices to be transposed.

17. The semiconductor apparatus of claim 9, wherein the logic coupled to the one or more substrates includes transistor channel regions that are positioned within the one or more substrates.

18. At least one computer readable storage medium comprising a set of executable program instructions, which when executed by a computing system, cause the computing system to:
determine a wordline size of a memory and a number of matrices to be transposed;
incorporate the wordline size and the number of matrices into an input instruction; and
issue the input instruction to a data controller associated with transposition hardware, wherein the input instruction is to instruct the transposition hardware to stream out transposed matrix data.

19. The at least one computer readable storage medium of claim 18, wherein the set of executable program instructions, when executed, further cause the computing system to incorporate a base address of a matrix in the memory, a row dimension of the matrix, and a column dimension of the matrix into the input instruction.

20. The at least one computer readable storage medium of claim 19, wherein the row dimension is to be different from the column dimension.

21. The at least one computer readable storage medium of claim 18, wherein the executable program instructions, when executed, further cause the computing system to incorporate a destination address into the input instruction.

22. The at least one computer readable storage medium of claim 18, wherein the instructions, when executed, further cause to computing system to perform one or more matrix multiplication operations on the transposed matrix data while the transposed matrix data is being streamed out.

23. A method comprising:
determining a wordline size of a memory and a number of matrices to be transposed;
incorporating the wordline size and the number of matrices into an input instruction; and
issuing the input instruction to a data controller associated with transposition hardware, wherein the input instruction instructs the transposition hardware to stream out transposed matrix data.

24. The method of claim 23, further including incorporating a base address of a matrix in the memory, a row dimension of the matrix, and a column dimension of the matrix into the input instruction, wherein the row dimension is different from the column dimension.

25. The method of claim 23, further including incorporating a destination address into the input instruction.
